(19) United States
(12) Patent Application Publication
(10) Pub. No.: US 2003/0062334 A1
(43) Pub. Date: Apr. 3, 2003

(54) Method for forming a micro-pattern on a substrate by using capillary force

(76) Inventors: Hong Hie Lee, Seoul (KR); Kab Yang Suh, Seoul (KR); Youn Sang Kim, Seoul (KR); Pil Jin Yoo, Seoul (KR)

Correspondence Address: David A. Einhorn, Esq., Anderson Kill & Olick, P.C., 1251 Avenue of the Americas, New York, NY, 10020, US

(21) Appl. No.: 09/967,081

(22) Filed: Sep. 28, 2001

(51) Int. Cl. B44C 1/22

(52) U.S. Cl. 216/37

(57) ABSTRACT

In a method for forming a micro-pattern on a substrate by employing a mold having a predetermined pattern structure, a mold having a predetermined pattern structure containing a recessed portion and a protruded portion is prepared. A polymer material is deposited on the substrate. Then the protruded portion of the mold is controlled to be in contact with the polymer material and the polymer material in contact with the protruded portion of the mold is incorporated into an empty space of the recessed portion thereof by using capillary force thereof, thereby removing the polymer material in contact with the protruded portion of the mold. Thereafter, a portion of the top surface of the substrate is exposed by detaching the mold to thereby form a polymer micro-pattern on the substrate.

### FIELD OF THE INVENTION

The present invention relates to a method for forming a micro-pattern on a substrate such as a silicon, a ceramic, a metal or a polymer layer; and, more particularly, to a method for forming a super micro-pattern having a size ranging from 1 μm to several ten's of nm by using capillary force in manufacturing an integrated circuit, an electronic device, a photo device, a surface acoustic wave filter, and so forth.

### BACKGROUND OF THE INVENTION

It is well known in the art that a micro-pattern is formed on a substrate so as to manufacture, e.g., semiconductor, electronic, photo electric and magnetic display devices. One of the conventional micro-pattern forming methods is a photolithography technique using light.

In the photolithography technique, a polymer material, e.g., photoresist, having reactivity to light is coated on a substrate on which a material to be patterned is laminated or deposited. Then, the polymer material is exposed to light irradiated thereon through a reticle designed to have a desired pattern. Thereafter, the exposed polymer material is removed while undergoing a developing process so that a patterning mask (or an etching mask) having a targeted pattern is formed on the material to be patterned. Next, the material deposited or laminated on the substrate is patterned to have the desired pattern by performing an etching process through the use of the patterning mask.

In the conventional photolithography technique, a line width or a pattern width is determined by the wavelength of the light irradiated on the polymer material during the exposure process. Thus, given the recent technology of the relevant art, it is difficult to fabricate a super micro-pattern of, e.g., a sub-100 nm on a substrate by using the photolithography technique.

As another micro-pattern forming method using light, there exists a technique to form a three dimensional shaped pattern on a large-area substrate through a multi-step process. However, the multi-step process is excessively time-consuming and complicated since various steps including a pattern forming, an etching and a cleaning steps are required. Accordingly, the manufacturing cost thereof may be high and the productivity thereof may be low.

Furthermore, the conventional light-using micro-pattern forming methods have a drawback in that when the surface of a substrate on which a pattern is formed is not flat, the process may become extremely complicated due to a reflection, a diffraction and an intensity-variation of the light.

To ameliorate the problems described above, there have been developed methods for forming a super micro-pattern of a sub-100 nm. As new methods of such kinds, a micro-contact printing method and an imprinting method are gaining popularity.

In the micro-contact printing process, a polymer mold having a targeted pattern is stamped on a substrate to obtain a desired pattern. A polymer mold, e.g., PDMS (polydimethylsiloxane) stamp inked with an appropriate solution of alkanethiol, is brought into contact with a surface of a substrate to transfer the ink molecules to those regions of the substrate that contact with the stamp. Then, an etching process or a depositing process is performed to obtain the desired pattern. This conventional micro-contact printing process has an advantage in that no particular external force is required. Since, however, a chemical etching process is employed in a finishing procedure of the micro-contact printing process, a rough pattern is obtained. As a result, a desired micro-pattern may not be obtained.

Meanwhile, the imprinting method is a technique to form a micro-pattern on a polymer layer by applying a physical pressure to a hard mold having a targeted pattern on the polymer layer to thereby transfer the micro-pattern on the polymer layer, e.g., by employing a reactive ion etching technique. However, in the conventional imprinting method, a polymer layer or a substrate can be easily deformed or even destroyed due to a high pressure involved.

### SUMMARY OF THE INVENTION

It is, therefore, an object of the present invention to provide a micro-pattern forming method capable of easily forming a desired micro-pattern by using capillary force.

In accordance with a preferred embodiment of the present invention, there is provided a method for forming a micro-pattern on a substrate by employing a mold having a predetermined pattern structure, the method comprising the steps of: preparing a mold having a predetermined pattern structure containing a recessed portion and a protruded portion; depositing a polymer material on the substrate; rendering the protruded portion of the mold to be in contact with the polymer material; incorporating the polymer material in contact with the protruded portion of the mold into an empty space of the recessed portion thereof by using capillary force thereof, thereby removing the polymer material in contact with the protruded portion of the mold; and exposing a portion of the top surface of the substrate by detaching the mold to thereby form a polymer micro-pattern on the substrate.

In accordance with another preferred embodiment of the present invention, there is provided a method for forming a micro-pattern on a substrate by employing a mold having a predetermined pattern structure, the method comprising the steps of: preparing a mold having a predetermined pattern structure containing a recessed portion and a protruded portion; depositing a thin film layer on the substrate; forming a polymer material on the overall surface of the thin film layer; rendering the protruded portion of the mold to be in contact the polymer material; incorporating the polymer material in contact with the protruded portion of the mold into an empty space of the recessed portion thereof by using capillary force thereof to remove the polymer material in contact with the protruded portion of the mold, thereby forming a polymer pattern of a predetermined shape; etching the thin film layer by employing the polymer pattern as a mask to thereby selectively remove a portion of the thin film layer; and removing the polymer pattern to thereby form a desired thin film micro-pattern.

### BRIEF DESCRIPTION OF THE INVENTION

The above and other objects and features of the present invention will become apparent from the following description given in conjunction with the accompanying drawings, in which:

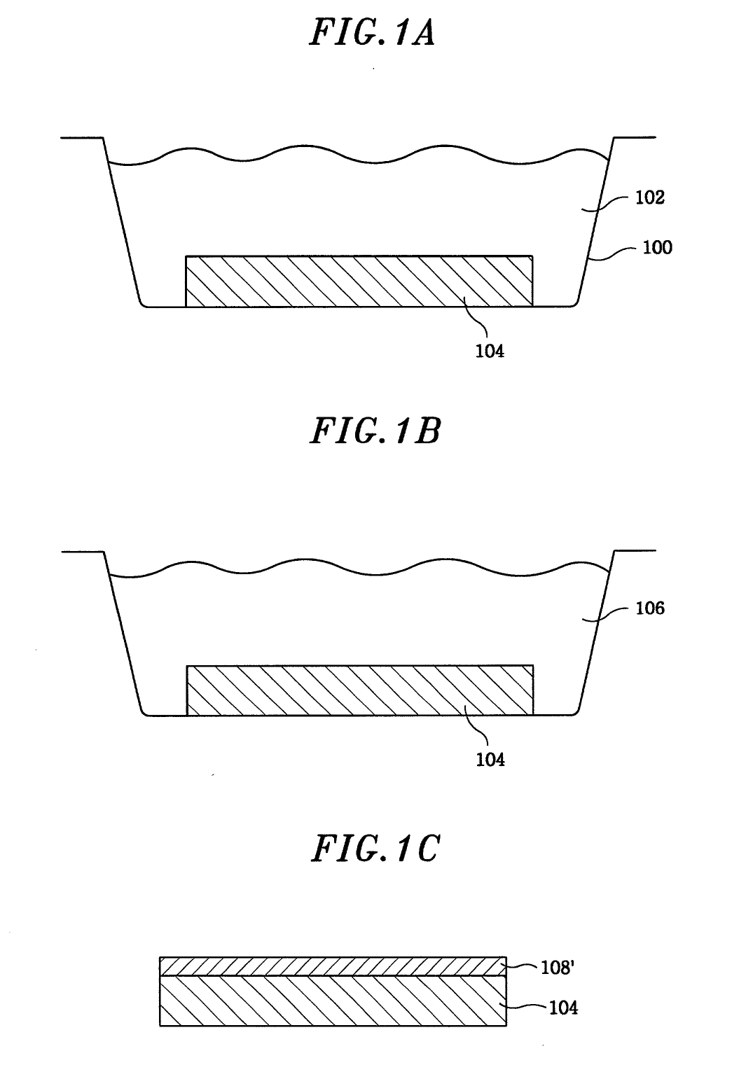

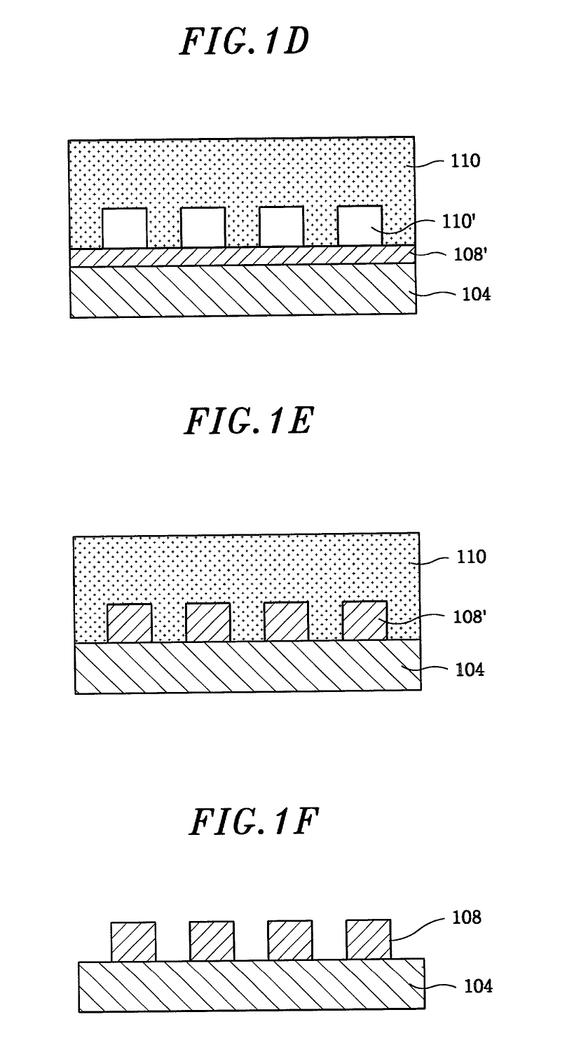

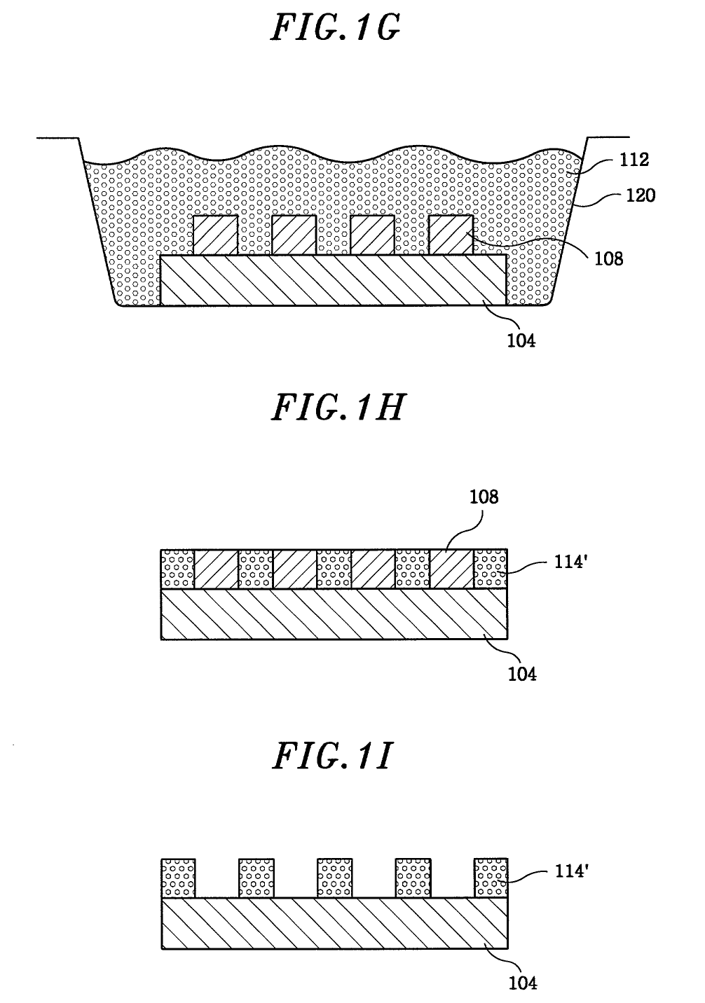

FIGS. 1A to 1I show diagrams representing sequential steps of a process for forming a thin film micro-pattern on a substrate by using capillary force in accordance with a first preferred embodiment of the present invention;

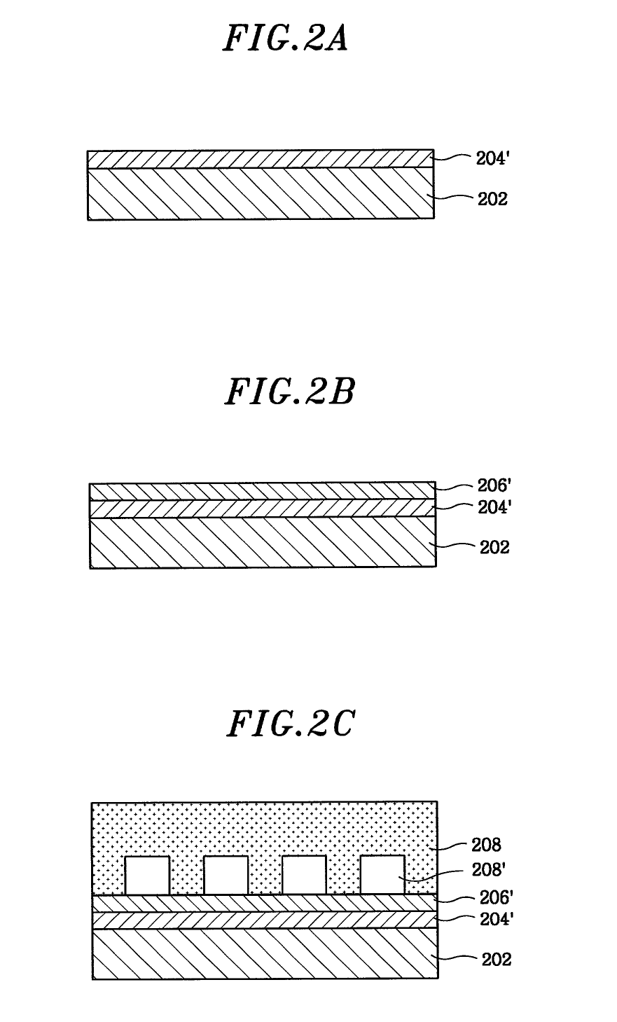

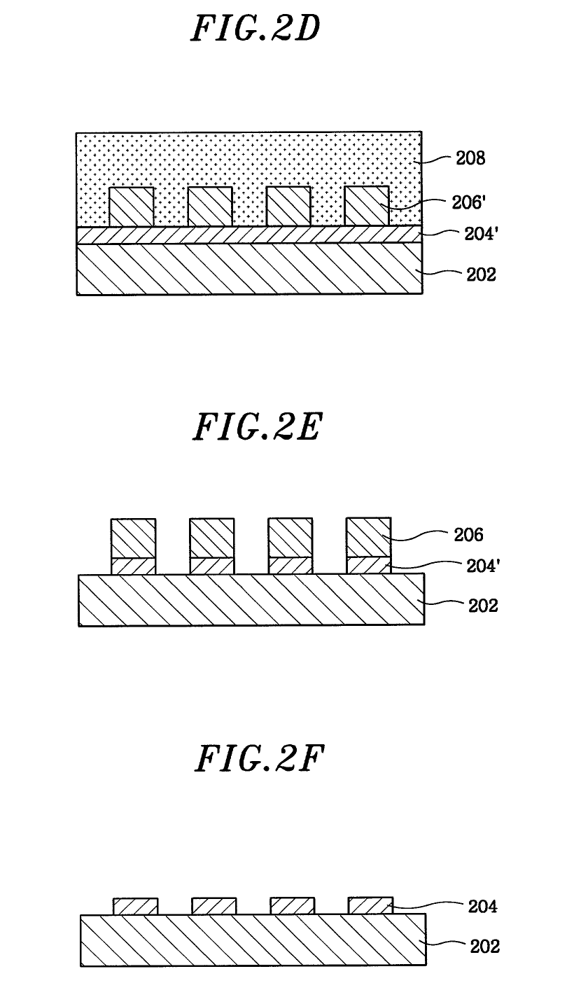

FIGS. 2A to 2F illustrate diagrams representing sequential steps of a process for forming a thin film micro-pattern on a substrate by using capillary force in accordance with a second preferred embodiment of the present invention; and

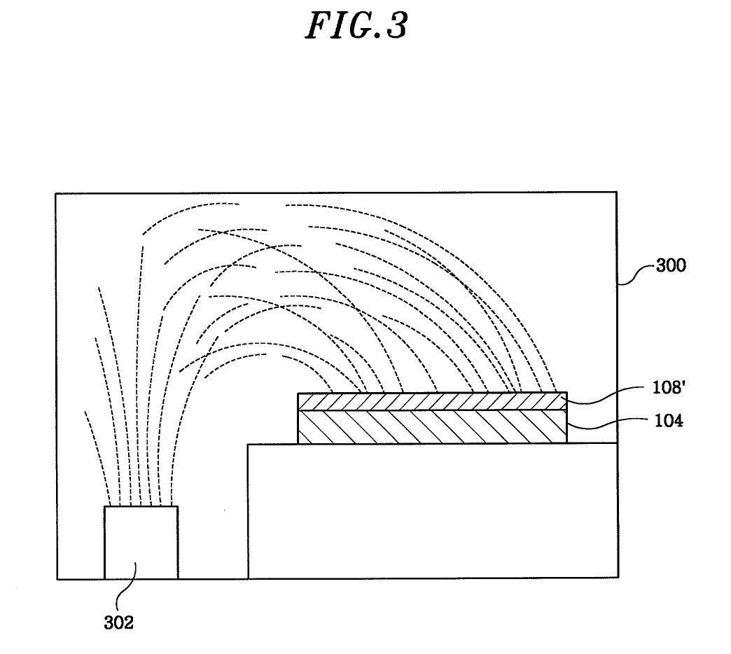

FIG. 3 provides a schematic diagram showing a situation that a fluidizing material is permeated into a polymer material on a substrate prepared in a sealed vessel to thereby obtain fluidity of the polymer material, the sealed vessel containing therein a bath filled with the fluidizing material.

### DETAILED DESCRIPTION OF THE INVENTION

The technical essence of the present invention lies in the use of capillary force for forming a micro-pattern on a substrate. First, a polymer mold having a desired pattern is prepared. Then, the polymer mold is brought into contact with a polymer material coated on a substrate so that the polymer material is incorporated into an empty space, i.e., a recessed portion, of the polymer mold by employing the capillary force to thereby form a targeted micro-pattern on the substrate.

The followings are various micro-pattern forming methods using the capillary force in accordance with the present invention.

First, when a polymer material, e.g., polystyrene, on a substrate has fluidity, a polymer mold is brought into contact with a polymer material prepared on a substrate so that the capillary force is induced and a targeted pattern is formed thereon.

Second, when a polymer material is a material devoid of fluidity, the polymer mold is brought into contact with the polymer material and then a heat treatment, e.g., heating, is performed to the polymer material at a predetermined temperature range so that the capillary force is induced and a desired micro-pattern is obtained thereon.

Third, when a polymer material is a material devoid of fluidity, a solvent, e.g., PGMEA (propylene glycol mono ether acetate) is permeated or absorbed into a polymer material prepared on a substrate to give the fluidity to the polymer material. Thereafter, a polymer mold is brought into contact with the polymer material so that capillary force is caused and a targeted micro-pattern is obtained. An inorganic mold such as a SiO₂ mold can be used in lieu of the polymer mold (PDMS polymer mold).

FIGS. 1A to 1I show diagrams representing sequential steps of a process for forming a thin film micro-pattern on a substrate by using capillary force in accordance with a first preferred embodiment of the present invention.

Referring to FIG. 1A, a silicon substrate 104 is subjected to an ultrasonic cleaning for a preset time, e.g., 5 minutes, in a bath 100 containing therein trichloroethylene solution 102. Then, as shown in FIG. 1B, the silicon substrate 104 is put into a bath 106 containing therein methanol solution, where an ultrasonic cleaning is performed again for a preset time, e.g., 5 minutes. Thereafter, the methanol-cleaned silicon substrate 104 is finally cleaned by using distilled water. Though a silicon substrate is exemplified as a substrate to be patterned in this preferred embodiment, a substrate made of other materials such as a ceramic, a metal, and a polymer can also be employed.

Next, as shown in FIG. 1C, a polymer material 108′, e.g., polystyrene, dissolved in toluene is coated on the silicon substrate 104 by using a spin-coating technique well known in the art, wherein the thickness of the polymer material 108′ coated on the substrate 104 is controlled to be, e.g., about 100 nm.

As illustrated in FIG. 1D, a polydimethylsiloxane (PDMS) mold 110 having a desired micro-pattern is brought into contact with the polymer material 108′. The reference number 110′ in FIG. 1D represents an empty space, i.e. a recessed portion, of the PDMS polymer mold 110.

In case the polymer material 108′, e.g., polystyrene, formed on the silicon substrate 104 has fluidity, the polymer mold 110 is brought into a conformal contact with the polymer material 108′ while the fluidity of the polymer material is being maintained. Then, a capillary phenomenon occurs so that the polymer material 108′ is permeated into an empty space 110′ of the polymer mold 110. As a result, a protruded portion of the polymer mold 110 comes into a direct contact with the silicon substrate 104. It should be noted that the empty space 110′ of the polymer mold 110 need to be large enough to accommodate all the polymer material 108′ formed on the silicon substrate 104.

However, when the polymer material 108′, e.g., the so-called a novolac resin is a material which does not have fluidity, an additional step for fluidizing the polymer material is required so as to induce capillary force. Two methods for fluidizing a non-fluid polymer material are suggested in this preferred embodiment.

In a first method, a non-fluid polymer material can be fluidized and incorporated into the empty space 110′ of the polymer mold 110, as shown in FIG. 1E, by heat-treating the silicon substrate 104 being in contact with the polymer mold 110 in a furnace at, e.g., about 110° C. for about 3 hours.

As is well known in the art, most polymer materials have their own glass-transition temperatures. When heated above the glass transition temperature, a polymer material is fluidized. Accordingly, if a mold having a shape capable of pulling up the polymer material is brought into a conformal contact with the polymer material, the polymer material moves into an empty space of the polymer mold.

FIG. 3 provides a schematic diagram showing a situation that a fluidizing material is permeated into a polymer material on a substrate prepared in a sealed vessel to thereby obtain fluidity of the polymer material, the sealed vessel containing therein a bath filled with the fluidizing material.

In FIG. 3, a fluidizing material, e.g., a solvent such as PGMEA is put into a bath 302 in a sealed vessel 300 so as to permeate the fluidizing material into a non-fluid polymer material 108′ formed on a substrate 104. When the fluidizing material evaporated from the bath 302 is absorbed into the polymer material 108′, the polymer material 108′ obtains fluidity. As a result, the polymer material 108′ is fluidized.

Though not shown in FIG. 3, a heating device for heating the bath 302 is further included in the sealed vessel 300 so as to accelerate the evaporation of the fluidizing material from a fluidizing material accommodated in the bath 302 and improve the absorption of the fluidizing material into the polymer material 108′. Accordingly, a time period required for providing the polymer material 108′ with the fluidity can be considerably reduced, which in turn diminishes a whole process time required for the patterning of a substrate.

As described above, the polymer material 108′ can be incorporated into the empty spaces 110′ of the polymer mold 110 by using capillary force induced by various methods described above.

When the polymer material 108′ is all incorporated into the empty space 110′ of the polymer mold 110 by using the capillary force, the polymer mold 110 is removed and a desired polymer pattern 108, i.e., a micro-pattern is obtained on the silicon substrate 104, as shown in FIG. 1F.

By using thus obtained polymer pattern, a micro-pattern of, e.g., a metallic wiring can be prepared on a substrate.

For example, as shown in FIG. 1G, the silicon substrate 104 having the polymer pattern 108 formed thereon is subjected to a reactor 120 containing therein an electroless plating solution 112. As a result, as shown in FIG. 1H, a thin film micro-pattern 114′, e.g., made of Al or Cu, having a desired thickness grows on certain portions of the surface of the silicon substrate 104 where no polymer pattern is remained.

Thereafter, the polymer pattern 108 on the silicon substrate 104 is removed by using a solvent. Then, by drying the silicon substrate 104 through the use of nitrogen gas blown thereto, a targeted thin film micro-pattern is formed on a substrate made of, e.g., a conductor, an insulator, a semiconductor or an organic material.

Accordingly, unlike in the conventional micro-contact printing method and imprinting method, a desired micro-pattern can be easily and precisely formed on a substrate through a simple process using capillary force in accordance with the present invention.

FIGS. 2A to 2F illustrate diagrams representing sequential steps of a process for forming a thin film micro-pattern on a substrate by using capillary force in accordance with a second preferred embodiment of the present invention.

In the first embodiment, a thin film micro-pattern is obtained by forming a polymer pattern on a silicon substrate through the use of a polymer mold having a desired pattern and capillary force. A thin film layer grows at certain portions of the substrate surface where no polymer pattern is formed and then the polymer pattern is removed from the substrate.

In contrast, in the second embodiment of the present invention, a desired micro-pattern is formed on a silicon substrate by forming a polymer pattern on a silicon substrate through the use of a polymer mold having a desired pattern and capillary force. Then, an etching process is performed by using the desired micro pattern as an etching mask.

In a micro-pattern forming method in accordance with the second embodiment of the present invention, silicon substrate cleaning processes are substantially identical with those performed in the first embodiment as illustrated in FIGS. 1A to 1B.

Referring to FIG. 2A, a thin film layer 204′ having a predetermined thickness is formed on a silicon substrate 202 through a deposition process. Then, as shown in FIG. 2B, a polymer material 206′ having a preset thickness is coated on an entire surface of the thin film layer 204′ by employing, e.g., a spin coating technique. It should be noted that though the silicon is exemplified as a silicon substrate in this second preferred embodiment, the present invention can also be applied to a substrate made of a ceramic, a metal, a polymer or the like.

Then, if the polymer material 206′ has fluidity, a polymer mold 208 is brought into conformal contact with the polymer material 206′ and, if not, the polymer material is subjected to another process such as a heat-treating step or a solvent-permeating step as described in the first embodiment so as to provide the polymer material with fluidity before being brought into the conformal contact with the polymer mold 208. Then, the polymer material 206′ is incorporated into an empty space 208′ of the polymer mold 208.

Herein, all of the polymer material 206′ can be incorporated into the empty space 208′ of the polymer mold 208 or some of the polymer material 206′ can be left on the thin film layer 204′ by adjusting the thickness of the polymer material 206′.

Some of the polymer material 206′ is maintained on the thin film layer 204′ without being incorporated into the empty space 208′ of the polymer mold 208 so as to control an etching speed in an etching process to be described hereinafter.

After all or some of the polymer material 206′ is incorporated into the empty spaces 208′ of the polymer mold 208, the polymer mold 208 is detached from the thin film layer 204′ on the substrate 202 so that a polymer pattern 206 having a desired pattern structure is formed on the thin film layer 204′. Next, an etching process is performed by employing the polymer pattern 206 as an etching mask. Accordingly, a certain portion of the thin film layer 204′ is selectively removed as shown in FIG. 2E and thus the certain portion of the silicon substrate 202 is selectively exposed.

Thereafter, the polymer pattern 206 formed on the thin film layer 204′ is removed by using a solvent and the silicon substrate 202 having the thin film layer 204′ is dried by nitrogen gas blown thereto, so that a targeted micro-pattern 204 of a conductor, an insulator, a semiconductor or an organic object is finally obtained on the silicon substrate 202.

Accordingly, the same effect as in the first embodiment can also be obtained in the micro-pattern forming method in accordance with the second embodiment of the present invention.

As described above, unlike the conventional micro-contact printing method and the imprinting method, a polymer micro-pattern can be easily and precisely formed on a substrate through a simple process using a polymer mold (or an inorganic mold) and capillary force in accordance with the present invention. Further, by using the polymer micro-pattern prepared on the substrate as a thin film layer growth restrainer or as an etching mask, a targeted micro-pattern can be successfully formed on a substrate made of, e.g., a silicon, a ceramic, a metal, a polymer, or so forth.

While the present invention has been shown and described with respect to the preferred embodiment, it will be understood by those skilled in the art that various changes and modifications may be made without departing from the spirit and scope of the invention as defined in the following claims.

What is claimed is:

1. A method for forming a micro-pattern on a substrate by employing a mold having a predetermined pattern structure, the method comprising the steps of:
a) preparing a mold having a predetermined pattern structure containing a recessed portion and a protruded portion;
b) depositing a polymer material on the substrate;
c) rendering the protruded portion of the mold to be in contact the polymer material;
d) incorporating the polymer material in contact with the protruded portion of the mold into an empty space of the recessed portion thereof by using capillary force thereof, thereby removing the polymer material in contact with the protruded portion of the mold; and
e) exposing a portion of the top surface of the substrate by detaching the mold to thereby form a polymer micro-pattern on the substrate.

2. The method of claim 1, further comprising the step of:
c1) after said step c) but before said step d), performing a heat treatment to the polymer material at a preset temperature range.

3. The method of claim 1, further comprising the step of:
b1) after said step b) but before said step c), permeating a fluidizing material into the polymer material in order to provide fluidity to the polymer material.

4. The method of claim 1, wherein the mold is a polymer mold.

5. The method of claim 1, wherein the mold is an inorganic mold.

6. The method of claim 1, wherein the polymer material is formed on the substrate by employing a spin-coating technique.

7. The method of claim 1, further comprising the steps of:
f) depositing a thin film layer on an exposed portion of the top of the substrate; and
g) removing the polymer micro-pattern to thereby form a desired thin film micro-pattern.

8. The method of claim 3, wherein said step b1) includes the step of heating the fluidizing material to increase the evaporation thereof, thereby enhancing the permeation of the fluidizing material into the polymer material.

9. The method of claim 7, wherein the polymer micro-pattern is removed by using a solvent.

10. The method of claim 7, wherein the substrate is selected from the group consisting of a conductor film, an insulating film, a semiconductor film and an organic film.

11. The method of claim 8, wherein the polymer material is a novolac resin and the fluidizing material is PGMEA (propylene glycol mono ether acetate).

12. A method for forming a micro-pattern on a substrate by employing a mold having a predetermined pattern structure, the method comprising the steps of:
a) preparing a mold having a predetermined pattern structure containing a recessed portion and a protruded portion;
b) depositing a thin film layer on the substrate;
c) forming a polymer material on the overall surface of the thin film layer;
d) rendering the protruded portion of the mold to be in contact the polymer material;
e) incorporating the polymer material in contact with the protruded portion of the mold into an empty space of the recessed portion thereof by using capillary force thereof to remove the polymer material in contact with the protruded portion of the mold, thereby forming a polymer pattern of a predetermined shape;
f) etching the thin film layer by employing the polymer pattern as a mask to thereby selectively remove a portion of the thin film layer; and
g) removing the polymer pattern to thereby form a desired thin film micro-pattern.

13. The method of claim 12, further comprising the step of:
h) after said step d) but before said step e), performing a heat treatment to the polymer material at a preset temperature range.

14. The method of claim 12, further comprising the step of:
h) after said step c) but before said step d), permeating a fluidizing material into the polymer material in order to provide fluidity to the polymer material before in contact with the mold with the polymer material.

15. The method of claim 12, wherein the mold is a polymer mold.

16. The method of claim 12, wherein the mold is an inorganic mold.

17. The method of claim 12, wherein the polymer material is formed on the substrate by employing a spin-coating technique.

18. The method of claim 12, wherein the polymer pattern is removed by using a solvent.

19. The method of claim 12, wherein the substrate is selected from the group consisting of a conductor film, an insulating film, a semiconductor film and an organic film.

20. The method of claim 13, wherein a part of the polymer material is incorporated into the empty space of the mold through the heat treatment, thereby rendering a remained part of the polymer material to be left on a top of the thin film layer.

21. The method of claim 14, wherein said step h) includes the step of heating the fluidizing material to increase the evaporation thereof, thereby enhancing the permeation of the fluidizing material into the polymer material.

22. The method of claim 17, wherein the polymer material is a novolac resin and the fluidizing material is PGMEA (propylene glycol mono ether acetate).

23. The method of claim 20, wherein the remained part of the polymer material left on top of the thin film layer is removed through an etching process.
